(19) United States
(12) Patent Application Publication
(10) Pub. No.: US 2015/0218919 A1
(43) Pub. Date: Aug. 6, 2015

(54) SYSTEM TO BOOST THE PRESSURE OF MULTIPHASE WELL FLUIDS TO HANDLE SLUGS

(71) Applicant: Caltec Limited, Bedfordshire (GB)

(72) Inventors: Mirza Najam Ali Beg, Milton Keyes (GB); Mir Mahmood Sarshar, Buckinghamshire (GB)

(21) Appl. No.: 14/587,384

(22) PCT Filed: Jun. 26, 2013
(86) PCT No.: PCT/GB2013/051690

§ 371 Date: Dec. 31, 2014

(30) Foreign Application Priority Data
Jul. 3, 2012 (GB) 1211937.6

(51) Int. Cl. E21B 43/12; B04C 9/00; F16L 55/05; F17D 1/00; F17D 1/20; F17D 3/10; E21B 43/34; B01D 21/24

(52) U.S. Cl. CPC E21B 43/121; E21B 43/34; B04C 9/00; B01D 21/24; F17D 1/005; F17D 1/20; F17D 3/10; F16L 55/05

(57) ABSTRACT

A system and method for boosting the pressure of multi-phase fluids to enable handling of slug flow from oil and gas wells. The system is arranged to include a cyclonic separator having outlets of a first gas-rich line and a first liquid-rich line, a gravitational separator having outlets of a second gas-rich line and a second liquid-rich line, downstream of the cyclonic separator. There is also a gas compressor for boosting pressure in the second gas-rich line and a liquid pump for boosting pressure in the second liquid-rich line. The boosted gas and liquid is received by a commingler downstream which outputs a combined fluid flow. Control valves are provided at various stages of the system that are activated in response to slug flow detected by flow regime detectors upstream of the cyclonic separator. The system is, overall, able to be much smaller than a convention slug catcher system and, in fact, the gravitational separator may be comprised of a pipe section the same or similar to the inlet from the well.

### CROSS-REFERENCE TO RELATED APPLICATIONS

This application is the U.S. national phase of PCT international application number PCT/GB2013/051690 filed Jun. 26, 2013, which claims priority to United Kingdom application GB 1211937.6 filed Jul. 3, 2012, the disclosures and benefits of which are incorporated in their entireties by reference herein.

### TECHNICAL FIELD

The present invention relates to a fluid flow system and in particular but not exclusively to a system and a method for boosting the pressure of multiphase fluids and/or for improving the handling capability of slug flow.

### BACKGROUND TO THE INVENTION

Production from many oil and gas wells is restricted as the reservoir pressure drops and the downstream production and process system require a specific flowing wellhead pressure (FWHP) to operate. Ideally, the operators wish to reduce the FWHP or back pressure on the wells so that they keep producing at a stable manner and recovery from the field is maximised. At the same time they need to boost the pressure of the produced fluids so that they meet the requirements of the downstream production system.

There are a variety of ways to boost production by reducing the back pressure on wells either at surface (wellhead) or downhole near the production zone. There are obviously advantages in using surface mounted boosting systems which are easily accessible for maintenance purposes and can serve several wells by manifolding the production from the wells. A multiphase pump can also be utilised which boosts the pressure of produced gas and liquids without having to separate gas and liquid phases, boosting the pressure of each phase separately. Such multiphase pumps require a very high power as they handle the mixture of gas and liquid phases and have to cope with difficult operating conditions such as slugging (which will be described below) which affect their performance and efficiency, thereby reducing operating life.

One of the challenges which surface mounted boosting systems face is the flow regime of the multiphase mixture. The flow regimes associated with the flow of a mixture of gas and liquids (multiphase flow) are well known in the oil and gas industry. The key feature of such flow regimes is the variations in the instantaneous flow rate of gas and liquids (which give rise to changing flow regimes). This means that the instantaneous flow rate of gas or liquids entering the boosting systems such as pumps or compressors changes significantly and if nothing is done to calm the surge of gas or liquids, it could upset the operation of such boosting systems.

One of the flow regimes is known as “slug flow” which can be generated either along the well bore or at surface along the pipeline or risers which transport the well fluids to the downstream boosting systems or the process system. The main characteristics of slug flow are periods with a high flow rate of liquids with little to no gas content, interspersed with periods of mainly gas flow. The length of the liquid slug could be several times that of the pipeline diameter, typically ranging between 10 times to 100 times, or more, of the pipeline diameter. The length and severity of slug is also dependent on the profile of the pipeline and the rise and fall in its elevation along its path. Slug flow may also be experienced during start up of the system if some wells have been shut in for some time before they are opened to the boosting system. The traditional method for handling slugs is to have a large separator, known as a “slug catcher”, which has enough capacity to store the liquid slugs for gradual release to the process system. Slug catchers are effective but the large size is the main disadvantage of such a system.

### BRIEF DESCRIPTION OF THE DRAWING

FIG. 1 illustrates a system to boost the pressure of multiphase well fluids to better cope with slugs in a pipeline, according to the invention

### DETAILED DESCRIPTION OF THE INVENTION

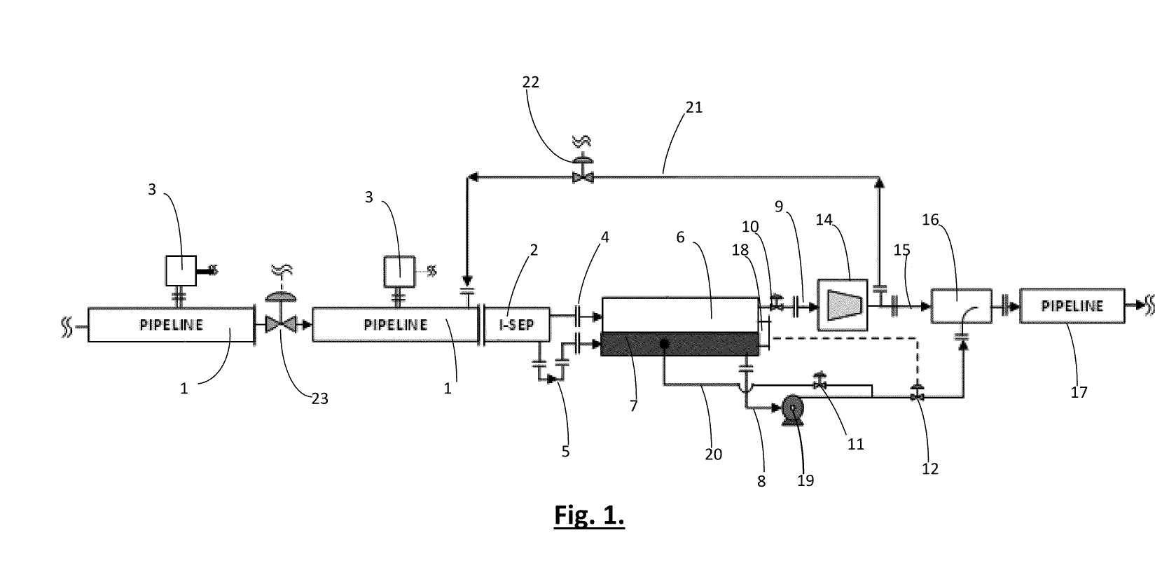

In an embodiment as illustrated by FIG. 1, the system of the invention may include of the following components:
At least one or a number of slug (flow regime) detection sensors 3;
A compact inline involute type uni-axial cyclonic separator 2, preferably of the type referred to herein as an I-SEP separator, an example of which is described in GB2453586A and/or U.S. Pat. No. 8,333,825, the disclosures of which are hereby incorporated by reference in their entireties herein however, alternative cyclonic separators are possible, e.g. an hydrocyclonic separator;
An inline pipe type slug handling system 6, preferably (effectively) comprising a gravitational separator stage. The main duty of the compact inline pipe type slug handling separator 6 is to remove bulk of liquids contained in the separated gas phase and to separate the bulk of gas carried under with the separated liquid phase downstream of I-SEP. In practice the gravitational separator may be comprised of a length of pipe, e.g. 0.5 m diameter 10 m length which is, in fact, the same/or similar/or not much greater in the size of section than the substantive part of the pipeline. By contrast, a conventional slug catcher may be 2-3 m in diameter and up to 40 m long;
A wet gas compressor 14 for handling the gas phase;
A liquid booster pump 19, or other methods for increasing liquid pressure, to boost the pressure of the liquid phase;
A commingling spool 16 which allows the boosted gas and liquid phases to be combined and fed to the pipeline system 17 for transport to the downstream production and process system.

There are also control valves (10, 11, and 12) which provide a main function of controlling the level of the liquids built up in the slug handling pipe line system 6, a level detector 18 for detecting the level of liquid in the slug handling system 6, and a control system (not shown) which controls the operation of control valves 10, 11 and 12.

The main function of the inline separator I-SEP 2 is to regulate and, to an extent, calm down the severity of a liquid slug as it reaches the boosting system. During normal production, the inline separator 2 provides the first stage of separation, delivering a gas rich fluid to the inline pipeline/gravitational separator 6 via gas-rich line 4, and a liquid rich fluid to the inline gravitational separator 6, via the liquid-rich line 5. The separator 6 can be of horizontal type as shown in FIG. 1 or, alternatively, it can be a vertical cylindrical type depending on site conditions and height constraints for the vertical separator. The separator 6 may also consist of multiple pipeline assemblies in order to reduce the diameter of each section to meet the liquid handling requirement and to simplify the design such as designing the system to pipeline code instead of the pressure vessel code as the system is made of purely a number of pipe sections (which might be the same as the main pipeline 1).

The slug handling system 6 has two functions; one is to improve the purity of gas delivered by I-SEP 2 during steady state flow conditions, so that the liquid content of gas fed to the gas compression system 14 is low and typically below 1% by volume of the mixture. The second function is to deliver liquids that are substantially free of gas to the liquid pumping unit 19. The inline slug handling unit 6 has enough capacity to hold a known part of the volume of the liquid slugs when they pass through the system and prevents the liquid pump 19 from being subjected to high liquid flow rates that are beyond its capacity, which would cause flooding of separator 6, and lead to liquids entering compressor system 14.

An added feature of the system is the provision of slug detectors 3 upstream of I-SEP 2. These slug detectors 3 are preferably a non-intrusive device and may, for example, be an accelerometer, an ultrasonic device or a similar device attached to the pipeline that detect either the noise generated by the slug or a sudden change in the density of the fluid mixture, which affects ultrasonic waves passing through the mixture. The function of the slug detector 3 is to detect the front edge of the slug before it reaches I-SEP 2. This early detection of a slug approaching the system allows the control system (not shown) to activate the control valves (10 and 12) early enough to control the flow rate of liquids entering the system that are to be handled by the liquid booster pump 19. Early slug detection also allows the control system to control the level of the liquids built up in the slug handling separator 6 in order to prevent it from being flooded excessively and also to prevent the liquid level dropping below a set point that would allow gas to escape into the liquid line 8.

In extreme cases if the liquid level in separator 6 reaches a high-high set point, a control valve 23 on pipeline 1, upstream of I-SEP 2 can be activated and throttle the flow until the liquid level in separator 6 stabilises and drops below the high-high set point—which should be the maximum acceptable height for the liquid phase before the system is upset. This added feature helps to reduce the size of the separator 6 as it does not need to be sized to handle slug severity beyond a set value defined by slug velocity and length for each case.

As a further improvement to the slug detection aspect, a second slug detector device 3 is installed upstream of valve 23 that is, in effect, several meters away upstream of the other slug detector 3. By using two detectors, several meters apart, the velocity of the slug can also be computed. This additional information helps to activate valves 10, 12 or 23 early enough to prevent overloading the system with a higher than acceptable liquid rate.

The control valve 10 has also an important function of increasing the pressure of the gravitational separator 6 as soon as it receives a signal from slug detector 3. This function has an added benefit of increasing the back pressure on I-SEP 2, which in turn will have a partial choking effect on the slugs entering the system (thereby providing a slug calming effect), and it also prevents the liquid level in the slug handling unit 6 from rising excessively causing flooding of the vessel by the surge of the slug entering this separator. Without the help of I-SEP (“slug calmer”) 2 and valve 10 which is throttled when it receives a signal from the slug detector 3, the full force of a slug travelling at high velocity could overload the system including the slug handling separator 6.

The booster pump 19 may have a re-circulation line 20 which is equipped with a control valve 18. The function of this line and valve is to recirculate some liquid from downstream of the pump 19 back into the separator 6 in cases when the liquid flow rate entering the separator 6 is very low and, particularly, less than the minimum recommended flow rate which the booster pump 19 should receive.

It is noteworthy that a conventional slug catcher would be of much larger size than the vessel 6 so that it could take a full flow rate of slugs. However, according to the invention, by virtue of the slug calming I-SEP 2 and valves 10 and 12, the slug handling vessel 6 can be much smaller in size and the operation of the gas compressor 14 and liquid booster pump 19 will also be much smoother.

A further feature of the system is the recirculation line 21, equipped with a control valve 22. The function of this line and valve 22 is to allow gas from downstream of the compressor 14 to be recirculated in cases when a liquid slug (free of gas) enters the separator 6 and as a result the compressor 14 may be starved of gas during the passage of the liquid slug. In alternative forms, some inline wet compressors may have such a re-circulation line and valve 22 as an integral part of the compressor.

As illustrated, the comingler 16 has the important function of allowing boosted gas and liquids to be combined uni-axially and efficiently for feeding into pipeline 17, even if there is a difference between the pressure of the boosted gas and liquids, and without one stream exerting back pressure on the other.

A particular feature of the system described is that all key components of the system may be housed in a series of pipes so that they are completely protected from exposure to outside conditions or theft of components in remote unmanned areas. In such a case components such as the booster pump 19, valves 10 to 12, 22 and 23 etc may also be accommodated within a pipe system and not exposed as shown in the schematic FIG. 1. Slim line pumps exist which can be accommodated inside a pipe section, an example of which is a multi-stage impeller type or progressive cavity pumps (PCPs).

Unique aspects of the present invention include the following:
The slug-calming effect of the (1-SEP) cyclonic separator incorporated in the system;
The control system, including the slug detector(s) 3 and the valves (10, 11, 12 and 23) that control the flow of fluids through the gravity separator, the liquid pump 19 and the gas compressor 14.
The pipeline separator 6 which also has partial slug handling capacity
The wet gas compressor
The liquid booster pump
The commingler 16 to allow two streams with different pressure to be combined without one stream putting back pressure on the other.

1. A fluid flow system for oil and gas wells to boost pressure of multi-phase fluids for handling slug flow including:
an inlet pipeline from a well;
a cyclonic separator receiving the input pipeline and with outlets of a first gas-rich line and a first liquid-rich line;
a gravitational separator downstream of the cyclonic separator, receiving each of the gas-rich and liquid-rich lines, with outlets of a second gas-rich line and a second liquid-rich line;
a gas booster for boosting pressure in the second gas-rich line;
a liquid booster for boosting pressure in the second liquid-rich line;
a commingler for receiving and combining boosted gas and liquid downstream of the respective gas booster means and liquid booster means; and
an outlet pipeline downstream of the commingler.

2. The fluid flow system according to claim 1, further including a controller for monitoring and controlling the flow of fluids within the system so as not to flood the cyclonic separator.

3. The fluid flow system according to claim 2 wherein the controller includes a flow regime detector for monitoring the inlet pipeline to enable early detection of slug flow.

4. The fluid flow system according to claim 3 wherein the flow regime detector is an accelerometer, ultrasonic device or an equivalent non-intrusive device.

5. The fluid flow system according to claim 3 including at least two detector devices installed at a predetermined distance apart such that the velocity of a slug can be computed by the controller.

6. The fluid flow system according to claim 3 wherein the controller is able to actuate control valves respectively located in the second gas-rich line and a second liquid-rich line as a consequence of flow detected by the flow regime detector.

7. The fluid flow system according to claim 2 wherein the gravitational separator includes a level detector.

8. The fluid flow system according to claim 7 wherein, dependent on a liquid level detected in the gravitational separator, the controller is able to actuate a control valve located upstream of the cyclonic separator to throttle the flow until the liquid level drops below a predetermined point.

9. The fluid flow system according to claim 1 further including a liquid-rich recirculation line from a location downstream of the liquid booster into the gravitational separator.

10. The fluid flow system according to claim 9 including a control valve in the liquid-rich recirculation line.

11. The fluid flow system according to claim 1 further including a gas-rich recirculation line from a location downstream of the gas booster into a location upstream of the gravitational separator and/or the cyclonic separator.

12. The fluid flow system according to claim 11 including a control valve in the gas-rich recirculation line.

13. The fluid flow system according to claim 1 wherein key components of the system are housed in a series of pipes for protection from exposure to outside conditions or theft.

14. The fluid flow system according to claim 1 wherein the gravitational separator is of horizontal or vertical type.

15. The fluid flow system according to claim 14 wherein the gravitational separator is comprised of a pipe section the same as or substantially similar to the inlet pipeline section.

16. The fluid flow system according to claim 14 wherein the gravitational separator consists of multiple pipeline assembly sections.

17. A method for boosting pressure of multi-phase fluids to enable handling of slug flow from oil and gas wells, including:
positioning a cyclonic separator downstream of an input pipeline from an oil/gas well, the cyclonic separator having outlets of a first gas-rich line and a first liquid-rich line;
positioning a gravitational separator downstream of the cyclonic separator, receiving each of the gas-rich and liquid-rich lines, the gravitational separator having outlets of a second gas-rich line and a second liquid-rich line;
positioning a gas compressor for boosting pressure in the second gas-rich line;
positioning a liquid pump for boosting pressure in the second liquid-rich line;
positioning a commingler downstream of the respective gas compressor and liquid pump for receiving and combining boosted gas and liquid.

18. The method according to claim 17 wherein a flow regime detector is positioned for monitoring the inlet pipeline to enable early detection of slug flow.

19. The method according to claim 18 wherein at least two detector devices are positioned at a predetermined distance apart such that the velocity of a slug can be computed.

20. The method according to claim 18 wherein control valves are respectively positioned in the second gas-rich line and a second liquid-rich line, each being actuatable to control fluid flow in response to slug flow detected by the flow regime detector.

21. The method according to claim 18 wherein the liquid level is monitored in the gravitational separator and, when the liquid level exceeds a predetermined amount, a control valve positioned upstream of the cyclonic separator is actuated to throttle the flow until the liquid level drops below the predetermined amount.

22. The method according to claim 17 wherein a liquid-rich recirculation line is installed between a location downstream of the liquid pump and the gravitational separator.

23. The method according to claim 22 wherein a control valve positioned in the liquid-rich recirculation line is actuatable to recirculate some liquid from downstream of the liquid pump back into the gravitational separator in cases when the liquid flow rate entering the gravitational separator is lower than a predetermined amount.

24. The method according to claim 17 wherein a gas-rich recirculation line is installed between a location downstream of the gas compressor and a location upstream of the gravitational separator and/or the cyclonic separator.

25. The method according to claim 24 wherein a control valve positioned in the gas-rich recirculation line is actuatable to enable gas from downstream of the gas compressor to be recirculated in cases when a liquid slug (free of gas) enters the gravitational separator.

26. The method according to claim 17 wherein key components of the system are housed in a series of pipes for protection from exposure to outside conditions or theft.

27. The method according to claims 17 wherein the gravitational separator is comprised of a pipe section the same as or substantially similar to the inlet pipeline section.
